(19) United States
(12) Patent Application Publication
(10) Pub. No.: US 2021/0329995 A1
(43) Pub. Date: Oct. 28, 2021

(54) CONFORMING MASK AND SEAL ASSESSMENT SYSTEM

(71) Applicant: BendShape Mask, LLC, Purchase, NY (US)

(72) Inventors: Paul Henry Dietz, Redmond, WA (US); James Holbery, Redmond, WA (US); Adam Landa, Longwood, FL (US); Anlong Li, Redmond, WA (US); Siyuan Ma, Bothell, WA (US); Jesse Rodriguez, Round Rock, TX (US)

(21) Appl. No.: 17/239,457

(22) Filed: Apr. 23, 2021

Related U.S. Application Data
(60) Provisional application No. 63/015,420, filed on Apr. 24, 2020.
(60) Provisional application No. 63/082,406, filed on Sep. 23, 2020.

(51) Int. Cl. A41D 13/11; A62B 23/02; F21V 33/00

(52) U.S. Cl. CPC A41D 13/1161; F21V 33/0068; A62B 23/02; A41D 13/1107

(57) ABSTRACT

A protective face mask having a main textile portion adapted to be worn over the mouth and nose, and comprising a perimeter and a filter portion. The mask further comprises a deformable member secured to the main textile portion near the perimeter, the deformable member circumscribing at least a majority of main textile portion, and being adapted to be conformed to the physical features of a user's face through the use of pressure, such that when the deformable member is so conformed, the mask will fit snugly against the user's face so that gaps between skin and the deformable member are reduced, thereby creating an inner air space; and, a mask securing system operatively affixed to the main textile portion for keeping the face mask securely in place during breathing; wherein the filter adapted to permit the exchange air between the environment and the inner air space.

This application claims the benefit of U.S. Provisional Application No. 63/015,420 filed Apr. 24, 2020. This application claims the benefit of U.S. Provisional Application No. 63/082,406 filed Sep. 23, 2020. The contents of all of the aforementioned applications are incorporated herein by reference. This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The disclosed apparatus and methods relate to the field of personal protection systems, and in particular to face masks and respirators that may be worn by humans.

### BACKGROUND

Personal protective equipment (“PPE”) is available to healthcare professionals and ordinary consumers in innumerable designs and form factors. However, one of the most important and ubiquitous pieces of PPE is the personal use face mask (e.g., surgical or all purpose mask and respirators). Such personal use masks may be single use, or reusable. A PPE face mask (or just face mask or mask) is intended to protect the human respiratory system from intrusion or expulsion (of, e.g., organic and inorganic matter) through the respiratory pathways (i.e., nose and mouth) by placing a filtering material between the environment and the respiratory system. In their most basic form, a face mask design involves a structure that covers the nose and mouth, allowing a user to inhale air while keeping unwanted matter out. In some instances, the face mask is intended to protect other people from the wearer. In other instances, the mask is intended to protect both the wearer and others.

In general, manufacturers endeavor to maintain production costs low by producing masks in large quantities, and only in a handful of standard mask sizes. Naturally, the health care professionals and ordinary consumers that use these PPE masks have widely diverging physical features that prevent even the varied sizes of the masks from appropriately fitting every user. Only a percentage of the consuming public—namely, those for whom one of the standard mask sizes is appropriate—benefits from the full filtering potential of the masks. Many masks, whether commercially produced or homemade, do not adequately seal against the face. The lack of an adequate seal can result in exposure to (e.g., inhalation of) airborne matter intrusion. Even where the masks appear to conform to the facial features of the user, gaps may remain, and therefore, exposure, might still result. Further, where a mask appropriately conforms to the features of a user and may form an adequate seal, movement of the mask or facial features may cause the mask to no longer conform or no longer adequately seal against the face.

Many existing mask manufacturing techniques center around thermoforming. Thermoforming may require heating a thermoplastic material and shaping it in a mold. Thermoformed masks tend to be more rigid in construction due to the melting process and therefore conform less to the complex curvatures of facial structures. This lack of conformance can lead to gaps and a poor seal between the face and mask. In some processes, masks are made by a machine that ultrasonically welds layers of plastics, including textiles and filtering materials. Additional components such as nose strips and straps may then be affixed or stamped to the masks.

There is a need for an improved mask and method of manufacturing thereof that creates an appropriate seal between a mask and its user.

### BRIEF DESCRIPTION OF THE DRAWINGS

The foregoing and other objects, features, and advantages of the disclosure will be apparent from the following more particular description of embodiments as illustrated in the accompanying drawings in which reference characters refer to the same parts throughout the various views. The drawings are not necessarily to scale, emphasis instead being placed upon illustrating principles of the disclosed embodiments.

FIG. 1 is a front view of a face mask in an expanded state worn by a user.

FIG. 2 is a front view of a face mask in a flat state.

FIG. 2 is a back view of the face mask of FIG. 3.

FIG. 4 is a back view of a face mask incorporating a material in an expanded state.

FIG. 5 shows an illustrative layer stack-up of a panel of a face mask.

FIG. 6 shows an illustrative layer stack-up of a panel of a face mask incorporating a material.

FIG. 7 shows an illustrative layer stack-up of a panel of a face mask incorporating a material.

FIG. 8 is an illustrative layer stack-up of a panel of a face mask incorporating a material.

FIG. 9 shows an illustrative layer stack-up of a panel of a face mask incorporating a material.

FIG. 10 shows an illustrative layer stack-up of a panel of a face mask incorporating a material.

FIG. 11 shows an illustrative layer stack-up of a panel of a face mask incorporating a material.

FIG. 12 is an illustration of a face mask with a mask-fit test system.

FIG. 13 is an illustration of a face mask with a mask-fit test system.

FIG. 14 is an illustration of a face mask with a mask-fit test system.

FIG. 16 is an isometric view of a face mask in an expanded state.

FIG. 17 is an isometric view of a face mask in an expanded state.

FIG. 18 is an isometric view of a face mask in an expanded state.

FIG. 19 is an isometric view of a face mask in an expanded state.

FIG. 20 is a front view of a nose piece with a butterfly-wing design.

FIG. 21 is a front view of a face mask with a transparent front panel in an expanded state.

FIG. 22 shows an illustrative layer stack-ups of a biodegradable transparent panel.

FIG. 23 shows an illustrative layer stack-ups of a biodegradable transparent panel.

### DETAILED DESCRIPTION

The present application describes various embodiments of face masks and methods for making and using face masks. The face masks and methods for making and using them disclosed herein are designed to provide a face mask that can conform to the features of its user, and to determine whether an appropriate seal exists between the mask and the user. In an embodiment, a face mask is provided with an embedded material around its periphery. In an embodiment, a face mask is provided with a material embroidered about its periphery.

As used herein the term “face mask” or “mask” refers to all face coverings (including surgical masks, all purpose masks, and respirators) capable of creating a barrier for the flow of organic and inorganic matter. As may be noted by those skilled in the art, a distinction may be drawn between “surgical/all purpose masks” and “respirators.” As used herein a “surgical” or “all purpose” mask refers to a loose fitting face covering that covers the nose and mouth area and is intended to be used as one-way protection—only capturing large particles or droplets exiting from the wearer and preventing them from being spread to the environment. As used herein a “respirator” refers to a tight fitting mask that creates a facial seal providing two-way protection by filtering the air entering and exiting the wearer. However, the apparatus and methods of manufacturing described herein apply to all masks including surgical/all purpose masks and respirators.

In an embodiment, masks are developed with the design, materials and processes to create embroidered textile architectures. Such masks can be manufactured using an in-place network of embroidery machine suppliers and small embroidery businesses. Masks, including custom masks, can be created locally and on demand, by leveraging that network. Masks made by the processes described herein can be built as FDA and National Institute for Occupational Safety and Health (NIOSH) approved masks. The Occupational Safety and Health Administration (OSHA) requires respirators be certified by NIOSH. In the NIOSH classification system, particulate respirators are given an N, R, or P rating. Each particulate respirator is also given a filter efficiency rating of 95, 99, or 100 when tested against particles that are the most difficult size to filter—approximately 0.3 microns in size mass median aerodynamic diameter (MMAD). MMAD is the diameter at which 50% of the particles of an aerosol by mass are larger and 50% are smaller. NIOSH class 95 particulate respirator filters are certified to be at least 95% efficient; class 100 particulate respirator filters are certified to be at least 99.97% efficient. The in-place network can establish a US nationwide mask manufacturing network. As described herein, a custom architecture for sealing the perimeter can be achieved by embedding e.g., form-fitting wires into the textile mask at the nose and uniquely around the chin and cheek areas. Additionally, inexpensive fiber can also be embroidered along the perimeter of the textile masks to enable quick inspection, (including a self-inspection) of mask fit against the face (and therefore antiviral effectiveness). These objectives are realized by creating embroidered, customizable mask designs to be produced by any commercial US embroidery platform. Employing the disclosed wire- and fiber-embedded embroidery technology is applicable to personal protection masks. Leveraging digital contour measurements which could be taken using a bend sensor to enable the production of precision and/or custom wire embedded, form-fitting masks. (The contents of the following United States Patent Applications, all directed to bend sensing, are incorporated herein by this reference: 62/748,984 filed Oct. 22, 2018; 62/887,324 filed Aug. 15, 2019; 62/887,291 filed Aug. 15, 2019; 62/903,272 filed Sep. 20, 2019; 62/925,214 filed Oct. 23, 2019; 62/944,814 filed Dec. 6, 2019; 62/947,094 filed Dec. 12, 2019; 62/970,017 filed Feb. 4, 2020; 62/970,524 filed Feb. 5, 2020; 62/986,370 filed Mar. 6, 2020; and Ser. No. 16/270,805 filed Feb. 8, 2019.) The present developments disclosed can be implemented using embroidery machine language that can translate measurement to machine code, enabling tailorable facial-feature masks to be produced on any US embroidery platform. Moreover, materials can be used and tests can be run to certify mask designs to meet N95 FDA, NIOSH and ASTM F2100-19 specifications with commercial spunbound-meltblown-spunbound (SMS) polypropylene architectures. In an embodiment, custom measurements can be used to support daily just-in-time deliveries of custom-fit PPE masks for entire companies or teams.

In an embodiment, a multiple shape-forming disposable and/or reusable mask is created with embroidery technology. To date, embroidery has not widely been used to manufacture personal protection masks at scale. Feedback from healthcare workers and citizens indicates FDA-compliant masks do not adequately fit facial contours. This is addressed by embedding shape-forming material (e.g., wire) which can also be combined with a passive fiber-optic self-test within or near the mask perimeter. In an embodiment the process uses form-fitting material and fiber delivered from the embroidery spooling tray. In an embodiment, aluminum wire and optical fiber are embedded into a mask perimeter through operational commands delivered from the embroidery machine code. In an embodiment, malleable wires, e.g., aluminum wire on the mask perimeter enables the mask to conform tightly to the face. As will be described more fully below, in an embodiment, a transmissions medium such as a fiber optic or fiber optic wire allows for a passive self-test of mask fit and effectiveness where the wearer looks into a mirror and shines a light (e.g., smartphone flashlight) at a predetermined location or marked spot (e.g., a port, a fitting, a lens) on the mask to fiber-optically illuminate the mask's perimeter. In an embodiment, resulting transmission leakage (e.g., light leakage) will quickly reveal loose-fitting mask areas against the skin for fit correction.

The embroidery approach enables fundamental improvements in mask shape and leads to a superior base fit. Additionally, the embroidery approach introduces significant improvements in the manufacturing process in general including increases in efficiency during production at scale. Bend shape sensing (e.g., using multibend sensors) and/or other means for facial contour measurement (e.g., depth cameras) can be used to provide an accurate, affordable means to measure human facial contours and compile sensed data into actionable design metrics. Bend shape sensing provides digital shape contour measurements that enable the embroidery of highly-customized masks. In an embodiment, bend measurements and/or other facial contour measurements can be translated to design code for computer aided design (CAD) software (e.g., Inkscape®) or other programs that are typically used for designing embroidered structures. Moreover, large-scale collection of such data will produce information concerning typical and outlier population measurements of such things as: nasal bridge breadth; nose width; face width; Bitragion-chin; Bitragion-subnasal; Bizygomatic arc, lower face length, jaw-line contour, and nose-bridge-to-cheek contour. In an embodiment, the population information can be used to enable the identification and production of a matrix of mask designs that will better fit the identified distribution of human facial features, rather than the one size fits all or a few sizes fit all thinking that has pervaded the manufacture of PPE masks to date. In an embodiment, translating design code to embroidery machine code requires that each line is turned into a sewing object where specific stitching choices are made. In an embodiment, designs will be translated into the industry standard. Data Stitch Tajima (DST) machine format for consumption by a wide variety of embroidery machines.

In an embodiment, the use of embroidery as a method of manufacturing also allows for the use of materials with advantageous properties that may be further combined in unique and complementary ways. For instance, technical textiles and fabrics present superior characteristics in terms of filtration, fluid control, and sterilization as compared to traditional face mask materials. In an embodiment, face mask materials may be disinfected by traditional washing methods used in clothing. In an embodiment, face mask materials may be disinfected through an ultraviolet (UV) light treatment. In an embodiment, face mask materials may be disinfected through a chemical vaporization method. In an embodiment, face mask materials may be disinfected through heat-based sterilization (including steam).

An additional advantage of the embroidery process is the use of transparent materials and fabrics. The public in general, and healthcare professionals specifically, have expressed interest in masks that allow for unimpeded communication between users—especially non-verbal communication. In the medical context, healthcare professionals must rely on their observations of patients' physiological performance (e.g., respiratory rate, speech) to accurately diagnose and assess a patient's status. A transparent mask, as disclosed herein, with the appropriate characteristics in terms of filtration, fluid control, flammability, and biocompatibility can enhance patient-healthcare provider experience through better means of communication while keeping both, patient and provider, safe. Additionally, such a mask can be particularly important to the hearing impaired and in classroom settings where visual indications of speaking such as lip movement are required (i.e., teacher-student interactions, coaching, training, and musical gatherings).

Using the methods and apparatus described herein allows local production by enabling thousands of US embroidery small-businesses to produce personal protection masks. Embroidery businesses frequently underutilize their platforms as businesses are sometimes seen as seasonal (e.g. school jackets, baseball caps) and many rely on corporate embellished garment production. To scale for emergencies, assuming a single operator can produce 200 custom-fit masks per day, this equates to 10,000,000 masks/week. There are more than 10,000 embroidery machines in the US, thus, the present technology can be used to instantly ramp to a production capacity of 20,000,000 masks/week, subject only to the supply chain considerations required to distribute the raw embroidery materials.

Embroidery Manufacturing Techniques

As may be understood by those skilled in the art, embroidery, unlike weaving or knitting, does not construct a fabric. Instead, traditional embroidery (e.g., hand embroidery) has been used to embellish fabric or complement traditional sowing techniques for aesthetic reasons. However, novel methods leverage computing and automation to repurpose embroidery as an additive manufacturing process, in addition to a finishing process. Computer Numeric Control (CNC) embroidery machines complemented by computer vision systems allow for highly accurate stitch movements that would not be possible with manual processes (including manual sewing machines). This is known as machine embroidery.

While machine embroidery is still used to add visual or aesthetic elements to a product, a more sophisticated use involves adding technical features to an underlying material or combination of materials. This is known as technical embroidery and may be considered as a subset of machine embroidery. In essence, “technical embroidery” allows for a technical or engineered product created through the embroidery process. For instance, adding a decorative flower to fabric would not be considered technical embroidery because its ultimate purpose is to embellish the final product. However, if some physical property of the flower allowed it to change a characteristic (i.e., color or size) then that use would be considered technical embroidery.

Technical embroidery encompasses the use of smart or functional textiles and fabrics. Smart textiles and fabrics have unique properties that add value beyond that of a regular fabric. Moreover, smart textiles are “able to sense stimuli from the environment, to react to them and adapt to them by integration of functionalities in the textile structure. The stimulus as well as the response can have an electrical, thermal, chemical, magnetic or other origin.” Van Langenhove, L., Hertleer, C.: Smart clothing: a new life. Int. J. Clothing Sci. Technol. 16(1/2), 63-72 (2004). A subset of smart textiles encompasses electronic textiles (“e-textiles”) which enable the incorporation of electronic or electrical components (e.g., batteries, lights, sensors) to a base fabric or textile.

Embroidery machines generally include two main parts, a head or heads containing the needle(s), hook(s), and/or other modules and a pantograph for computer controlled movement which contains a frame to secure the underlying or backing material. Technical embroidery machines, such as those manufactured by ZSK® Stickmaschinen GmbH of Germany, contain different heads to achieve different embroidery techniques. These heads are largely categorized as either W-heads, K-heads, or F-heads and an embroidery machine may contain one, all, or a combination of these.

Depending on the type of head, an embroidery machine may also comprise a counterpart to the head (sometimes called an arm) that works in conjunction with the head to create specific stitches—the head being on one side of the material and the arm being on the other. For instance, F- and W-head machines includes a rotary hook and a bobbin containing a bottom thread in the arm (the top thread being located on the head)—when the needle descends from the head with the top thread and pierces through the material the rotary hook catches the top thread to create a lock stitch with the bottom thread. A K-head machine uses a hook needle (similar to a crochet needle) to pierce through the material from above and pull thread from the underside.

Further, modern embroidery machines may contain means for actuation (e.g. motors, servos, pneumatic clamps) and sensing (e.g. encoders, switches, cameras) that interact with a control system to effect the precise movement of the different parts. In the majority of embroidery machines the head(s) remains stationary while the pantograph translates in the x and y coordinates moving the material relative to the head. In the specific case of curved surfaces (e.g., baseball caps and hats) the pantograph translates and rotates about an axis while the head remains stationary. It may be noted that in the majority of head designs the needles move freely in the z-axis to achieve the desired stitch pattern. However, in K-head embroidery the needle must rotate about the z-axis to allow the hook to loop an unloop against the stitches. In contrast, in F and W heads the needle may not rotate.

In other machines, the fabric, backing, or base material remains stationary while the head moves about. Some embroidery machines allow for the continuous feed of at least one of fabric, backing, and base material. The material is wound on a spool (or multiple layers of materials are wound on different spools), and then unwound (and aligned in the case of multiple layers of material). The material or materials are then clamped one section at a time to the frame(s), embroidered, unclamped and moved through until the next section of the material can be clamped, repeating the process continuously.

As noted above, the integration of computer vision systems to embroidery machines allow for more precise direction and feedback to the control loop. These systems can identify and locate features on the material(s) or on the components to precisely place or secure components or subassemblies into the material. Additionally, vision systems can scan and identify defects on the materials or the components, or determine appropriate compliance with the design to exponentially improve the quality of the finished product.

Similar to other additive manufacturing techniques, the continuous addition of material (e.g., textiles, fabrics, carbon fiber) and thread allow for the construction of three dimensional parts using embroidery. Further, modular embroidery systems allow for the incorporation of components of various sizes from small sequin-sized electronic boards to flexible electrically conductive materials and inks in a precise and speedy manner. Similarly, discrete components or subassemblies (to be applied to the material) may be packaged in spools or rolls and fed continuously into a module that places and secures each individual component to the material thereby increasing exponentially the speed and accuracy of the manufacturing process as a whole.

In an embodiment, traditional circuit board techniques can be adapted to an embroidery process in order to increase the density of components or to avoid crisscrossing or mixing conductors and signals (which could lead to shorts or signal interference). For instance, the textile equivalents of blind and buried vias in printed circuit boards can be implemented on the embroidered material to place a set of conductors on one side of the material and another set of conductors on the other side of the material or in between layers of material. The conductors can then be interconnected through the fabric or material. The embroidery process can create different types of patterns or designs to enhance the functionality and performance characteristics of the embedded interconnections and components. For instance, a signal may be transmitted over a conductor near another signal transmitted over another conductor by using an insulated thread buffer between the two to separate the signals. In an embodiment, antennae may be woven through the material and secured to a circuit board embroidered to the material with conductive threads.

As noted above, modern embroidery machines may be adapted to suit any application by way of interchangeable modules. For instance, different cutting techniques may be implemented using special purpose modules. Some cutting modules use a fine cone of hot air (similar to water jet cutting machines) to create precise cuts in heavier materials such as leather or cotton. In these modules the temperature of the air may be tuned, not only to cut the materials, threads, or components being used, but to selectively melt or heat specific parts. In an embodiment, thermoplastic threads—with lower glass transition temperatures than the underlying material—may be selectively melted to seal holes in the underlying material (e.g., the holes caused by the stitch pattern). In an embodiment, thermoplastic threads may be deposited on or secured to a material or other layers of thread and selectively melted to create a three dimensional structure.

Other cutting modules may use either low-power lasers or very large high-powered gold lasers, depending on the application, that allow for rapid and precise cuts. These modules enable operators to limit human intervention in the manufacturing process thereby increasing throughput and consistency. In an embodiment, a base material may be fed into the machine, embroidered, and then cut for a complete product with little or no human interaction with the machine or material.

However, traditional cutting processes can also be applied. In an embodiment, a die cutting press (or a clicker press) can be used to individually cut pieces of material containing sub assemblies or completed products from the underlying material (e.g., mask layers, or a completed mask). In an embodiment, a roll die cut may also be used to cut one or multiple masks at a time.

Similarly, cording modules—traditionally used for the embroidery of cords, leather strands, ropes, or patterned ribbons to fabric—may be repurposed to embroider malleable or fine wires into the material. Cording modules are usually used with F-heads and are reserved for smaller diameter wire. For larger wires, optical fibers, or cables, a W-head may be used. Both the cording modules and W-heads use a zigzag stitch to secure the wires, optical fibers, or cables to the material.

Boring modules use a knife-like needle to pierce the material selectively in different directions. While not as accurate as other cutting techniques, boring techniques are much faster and can be used to create rough outlines and cuts. Additionally, boring modules may be used with fabrics that have high melting points (e.g., teflon fabrics) and cannot be cut efficiently with a hot air process.

### Net Shape Filtration Material Manufacturing Process

In some manufacturing processes, the layers of material required to assemble the masks and respirators are supplied in sheet or roll forms. Because of the intricacy of some of the designs (like those described herein), traditional manufacturing processes waste large portions of the material stock. Up to 20% of the material may be rendered useless and discarded ultimately deposited in a landfill. An aspect of the present invention is the net shape manufacturing of masks and respirators through the deposition of polymers, fibers, and other media. This manufacturing process combines electrospinning, polymer spray, and casting to deposit material in a specific configuration to create an end product with a desired filtration level and a final or almost final shape.

As will be known by those skilled in the art, electrospinning fibers is widely used for the production of nanofibers. This technique employs electrostatic forces for stretching a viscoelastic fluid producing fiber diameters on the order of 1-2× smaller than conventional spinning techniques. Electrospinning is capable of achieving large surface to volume ratios that can be leveraged in antibacterial surfaces, scaffolds, nanofilters and water-proof fabrics. In its most basic configuration the process employs a syringe pump, a high voltage current and a grounded collector. However, controlling the polymer flow rate, temperatures, and other variables, requires a deep understanding of the material properties involved. Electrospinning can then be combined with polymer spraying, melt-blowing or thin film deposition through an aerosol technique, extrusion, fiber filtration combined with imposed short-range forces, heating, or pressing to create intricate masks with intricate shapes that can not be achieved through traditional manufacturing techniques while achieving high levels of filtration.

In an embodiment, a mask or pieces (e.g., panels) of a mask as described herein are manufactured by depositing a calendared amount of material (e.g., fibers) through electrospinning into a mold to achieve a tightly controlled thickness. The individual pieces are subsequently assembled either through sewing, ultrasonic welding, adhesive bonding, embroidery, or any other manufacturing process.

### Embroidered Mask

An aspect of the present invention is a face mask with a material embroidered about its periphery. In an embodiment, the material is a conformable material that is able to conform to the user's facial features. In an embodiment, the material is a conformable material that is adapted to be conformed to the user's facial features when the mask is used.

In an embodiment, the material permits a transmission therethrough, but which transmission is mitigated when the mask is worn in a manner providing adequate protection. In an embodiment, the transmission is largely or completely shielded from detection when the mask is worn in a manner providing adequate protection. In an embodiment, a detector that can detect the transmission can be used to detect gaps between the mask and the face. In an embodiment, the transmission is light, and gaps can thus be seen or detected with a photosensitive element. In an embodiment, the transmission is light in the optical range, and gaps can thus be seen or detected with an appropriate photosensitive element. In an embodiment, the transmission is light outside the optical range, and gaps can be detected by a photosensitive element sensitive to the wavelengths of the light transmitted. In an embodiment, the transmission is electrical. In an embodiment, the transmission is in the radio frequency (RF) range. In an embodiment, the transmission is acoustic.

In an embodiment, the material is a fiber optic that can be used for a light transmission, but permits light to exit along its path (i.e., lacks totally frustrated internal reflection). In an embodiment, the fiber optic is Fibrance®, a light-diffusing fiber sold by Corning Incorporated of Corning, N.Y. In an embodiment, a light is operatively connected to the material from within or without the mask. In an embodiment, the light is not red so it can easily be distinguished from light passing through the skin. In an embodiment, the light is green so it can easily be distinguished from light passing through the skin. In an embodiment, the light is blue so it can easily be distinguished from light passing through the skin. In an embodiment, the material is both a conformable material that is able to conform to the user's facial features and a material that permits a transmission along its path.

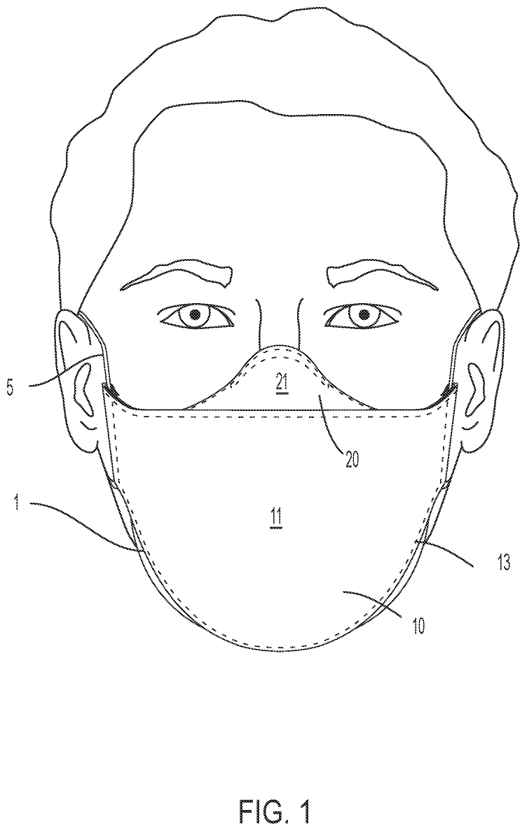

Referring now to FIG. 1, a front view of an embodiment of a face mask 1 in an expanded state worn by a user is shown. In an embodiment, the mask is placed over the mouth and nose of the user. In an embodiment, the mask is placed over the eyes, nose, and mouth of the user and can comprise a transparent portion for others to observe the eyes, nose, and mouth of the user. In an embodiment, an embroidered mask is manufactured and stored in a substantially flat or collapsed state and is capable of unfolding to a three-dimensional expanded state.

As will be further explained below, in an embodiment, the mask 1 comprises a material (not shown) around its periphery that is hidden from view when the mask is worn correctly. In an embodiment, the mask 1 comprises a conformable material around its periphery. In an embodiment, the conformable material is a deformable member. In an embodiment, the material (e.g., a deformable member) circumscribes at least a portion of the perimeter. As used herein, the term “circumscribes” comprises restricting a portion of the mask. In an embodiment, the material is secured to less than the totality of the periphery. In an embodiment, the material is one continuous part. In an embodiment, the material may be several parts placed around the perimeter of the mask at discreet locations.

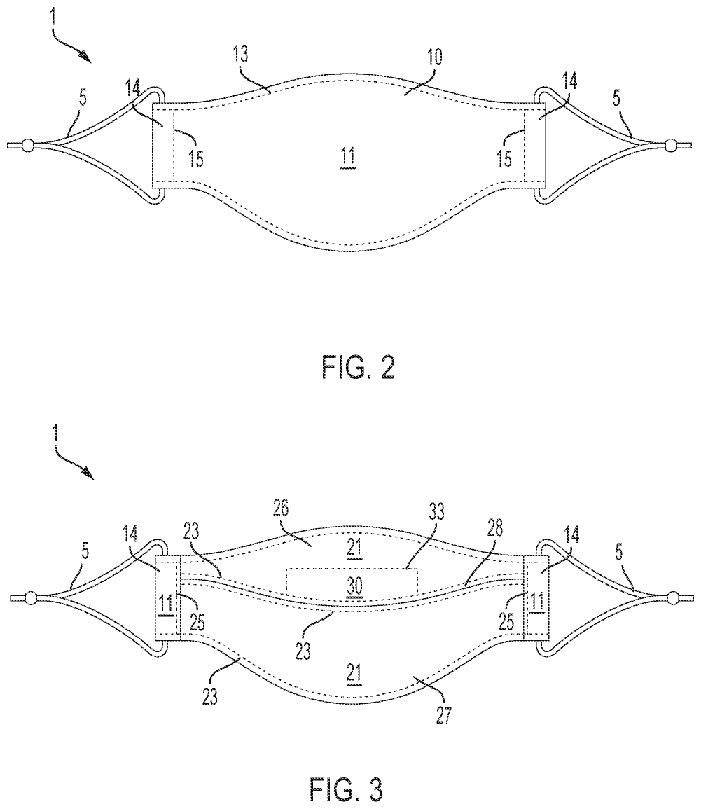

Turning now to FIGS. 2 and 3, a front and back view, respectively, of an embodiment of a mask 1 in a collapsed state is shown. In an embodiment, a mask 1 in a collapsed state is substantially flat. In an embodiment a mask 1 includes a front panel 10 and a back panel 20. In an embodiment, the front panel 10 and the back panel 20 have generally the same outline. In an embodiment, the front panel 10 and the back panel 20 have different outlines. In an embodiment, the front panel 10 and the back panel 20 are secured to each other by a front panel stitch 13. In an embodiment, the front panel 10 and the back panel 20 are secured to each other by a back panel stitch 23. In an embodiment, the front panel stitch 13 and the back panel stitch 23 are the same stitch.

As will be noted those skilled in the art, some stitch patterns require a top thread and a bottom thread to create a secure interlocked stitch. In an embodiment, a stitch pattern comprises a top thread and a bottom thread. In an embodiment, a stitch includes only one thread. In an embodiment, a stitch includes threads of different materials. In an embodiment, at least one of the top thread and the bottom thread is a polyester thread. In an embodiment, at least one of the top thread and the bottom thread is Polyneon® #40 Weight, a polyester thread sold by Madeira USA LLC Gilford, N.H. In an embodiment, at least some of the stitching is visible. In an embodiment, the stitching is not visible. In an embodiment, the stitching is concealed between layers. In an embodiment, a thread that can be selectively melted to create an impermeable barrier (i.e., by closing the hole) is used. In an embodiment, a thermoplastic thread is used.

As will be discussed in further detail below, in an embodiment, panels are manufactured individually and each panel comprises several layers of material. In an embodiment, the layers of a panel are secured to each other by a panel stitch. In an embodiment, the front panel 10 has an outer layer 11 and an inner layer 12. In an embodiment, the layers of front panel 10 are secured by the front panel stitch 13. In an embodiment, the back panel 20 has an outer layer 21 and an inner layer 22. In an embodiment, the layers of back panel 20 are secured by the back panel stitch 23. In an embodiment, front panel 10 and the back panel 20 are secured by at least one of the front panel stitch 13 and the back panel stitch 23. In an embodiment, the layers of the front panel 10 are secured by the front panel stitch 13 and the layers of the back panel are secured by the back panel stitch 23, however, the front panel 10 and the back panel 20 are secured to each other by another stitch.

In an embodiment, the front panel 10 and the back panel 20 include a front cord loop portion 14 and back cord loop portion 24 (hidden), respectively. In an embodiment, the front cord loop portion 14 and the back cord loop portion 24 create a cord loop when secured to each other. The cord loops are capable of receiving a cord 5 for securing the mask to a user. In an embodiment, the front cord loop portion 14 and the back cord loop portion 24 are secured to each other by at least one of the front cord loop stitch 15 and the back cord loop stitch 25. In an embodiment, the front cord loop portion 14 and the back cord loop portion 24 are secured to each other at a free end of each by at least one of the front cord loop stitch 15 and the back cord loop stitch 25 to create a cord loop capable of receiving a cord 5 (not shown). As noted above, some stitch patterns require a top thread and a bottom thread to create a secure interlocked stitch. In an embodiment, the front cord loop stitch 15 and the back cord loop stitch 25 are the same stitch.

In an embodiment, the front panel 10 and the back panel 20 have different outlines wherein either the front cord loop portion 14 or the back cord loop portion 24 protrude outside the outline of the opposing panel (e.g., portion 14 extends past back panel 20 or portion 24 extends past front panel 10). The free end of the protruding cord loop portion (i.e., the front loop portion 14 or the back cord loop portion 24) is then folded over and secured to at least one of the front panel 10 and the back panel 20 to create a cord loop capable of receiving a cord 5. In an embodiment, the free end of the cord loop portion 14 may be secured to at least one of the front back panel 10 and the back panel 20 with at least one of the front panel stitch 13, the back panel stitch 23, the front cord loop stitch 15, and the back cord loop stitch 25. In an embodiment, the free end of the cord loop portion 24 may be secured to at least one of the front back panel 10 and the back panel 20 with at least one of the front panel stitch 13, the back panel stitch 23, the front cord loop stitch 15, and the back cord loop stitch 25.

In an embodiment, the front panel 10 and the back panel 20 have the same outline wherein the front cord loop portion 14 and the back cord loop portion 24 overlap. In an embodiment, the front loop portion 14 and the back cord loop portion 24 are then folded over and secured to at least one of the front panel 10 and the back panel 20 to create a cord loop capable of receiving a cord 5. In an embodiment, at least one of the the front loop portion 14 and the back cord loop portion 24 is secured to at least one of the front back panel 10 and the back panel 20 with at least one of the front panel stitch 13, the back panel stitch 23, the front cord loop stitch 15, and the back cord loop stitch 25. As will be noted by those skilled in the art, the design and execution of the cord loop may be accomplished in a plurality of arrangements.

Still, in an embodiment, the mask 1 is secured to the user by a mask securing system. In an embodiment, the mask securing system includes cords. In an embodiment, the mask securing system includes straps. In an embodiment, the straps are secured directly to at least one of the front panel 10 and the back panel 20. In an embodiment, the straps are embroidered to at least one of the front panel 10 and the back panel 20. In an embodiment, the mask securing system comprises fasteners (e.g., snaps and buckles). In an embodiment, the straps can be integrally manufactured with at least one of the front panel 10 and the back panel 20. In an embodiment, the straps can be integrally manufactured with all the layers on the mask 1. In an embodiment, the straps are integrally manufactured with only some of all the layers on the mask 1. In an embodiment, the straps are manufactured from a different material than the mask 1. In an embodiment, the straps are manufactured from the same material as the mask 1. In an embodiment, the straps are secured to at least one layer by at least one of embroidering, sonic welding, welding, stitching, bonding, adhesion, and a thermal process.

### Curving Panels

Referring now to FIG. 3, in an embodiment, the back panel 20 comprises a top portion 26 and a bottom portion 27. In an embodiment, the top portion 26 and the bottom portion 27 of the back panel are separated along a separation line 28. In an embodiment, the separation line 28 extends the length of the back panel 20. In an embodiment, the separation line 28 extends a portion less than the length total length of the back panel 20.

In an embodiment, a mask 1 in a collapsed state is substantially flat. In an embodiment, when mask 1 is in a collapsed state, the top portion 26 and the bottom portion 27 lie flush (i.e., without either portion overlapping the other). In an embodiment, when mask 1 is in a collapsed state, the total thickness of the mask is equal to no more than two times the thickness of either the front panel 10 or the back panel 20. In an embodiment, when mask 1 is in a collapsed state, the total thickness of the mask is equal to the thickness of the front panel 10 plus the back panel 20.

As will be noted, facial contact is of critical importance to properly fitting a mask or respirator to the wide variety and diversity of facial contours and features of the users that may employ them. This is accentuated by the fact that most manufacturers of mask and respirators only provide a handful of standard sizes for their products. The vast majority of existing designs are not contoured to the face.

Aspects of this invention provide for a contoured contact surface that adapts to the facial features of the users thereby providing full-contact between the mask and user. Specifically with respect to the nasal bones and cartilages. With this emphasis in the contact area, a superior fit can be achieved. Ultimately, this superior fit significantly limits the passage of unfiltered air from outside the mask and provides the user a form fitting contact area increasing the ability of the mask to block nanometer-sized pathogens.

In an embodiment, such as that shown in FIG. 3, the separation line 28 delineates a downward curve towards the center of the panel thereby creating a top portion 26 that has an increased amount of surface area skewed towards the center of the panel. When the mask is in an expanded position, this increased area provides for a larger and more comfortable contact surface between the mask and nasal area of the user. However, it will be noted that in other embodiments, the separation line 28 has no such downward curve and is instead a straight line to preserve a larger area in the chin region. In an embodiment, the separation line 28 is an ellipsoid at the center of the panel.

### Nose Pieces and Conforming Materials

In the past, nose pieces (i.e., nose bridges) used in masks and respirators have been manufactured from aluminum alloy bars or plastic strips (e.g. polypropylene). A common issue faced by other designs is the loss of structural integrity of the nose piece(s) after a few cycles of usage. This leads to poor reusability, user discomforts, and loss of seal. The present invention contemplates nose pieces with increased longevity for a longer life cycle while retaining superior material pliability and flexibility that allows for a good seal around the nose bridge.

Aspects of the present invention relate to a nose piece manufactured using a shape memory alloy. In an embodiment, the user's body heat or the exhaled air increase the temperature of the nose piece above the phase transition temperature of the material. Once the material temperature crosses the phase transition temperature threshold the nose piece becomes pliable and conforms to the contours of the face (e.g., the nose or the chin) of the user. After the user removes the mask, the material temperature falls below the phase transition (or activation) temperature and the nose piece returns to a “memorized state”. In an embodiment, the memorized state is a straight configuration. In an embodiment, the memorized state is a curved dome configuration. In an embodiment, the shape memory alloy comprises a nickel—titanium alloy. In an embodiment, the nickel-titanium composition is selected based on the activation temperature requirement. In an embodiment, the shape memory alloy nose piece can be manufactured in any geometry desired (e.g., a straight bar, a butterfly-wing design as outlined below, or a curved dome design). In an embodiment, the shape memory alloy nose piece can have a “memorized state” design with an arbitrary shape.

Returning now to FIG. 3, in an embodiment, the top portion 26 comprises a nose piece 30. In an embodiment, the top portion comprises a plurality of nose pieces 30. In an embodiment, the nose piece(s) 30 is/are located on at least one of an inner layer 510 and an outer layer 530 (discussed in further detail below). In an embodiment, the nose piece(s) 30 is/are located between layers of the back panel 20. In an embodiment, the nose piece 30 is a unitary piece of material. In an embodiment, the nose piece 30 comprises multiple pieces of materials. In an embodiment, the nose piece(s) 30 comprises a deformable material. In an embodiment, the nose piece(s) 30 comprises a material capable of retaining a shape. In an embodiment, the nose piece(s) 30 comprises a metal.

In an embodiment, the nose piece(s) 30 are distributed throughout the top portion 26 to add rigidity and ensure an airtight seal between the user and the mask 1. In an embodiment, the nose piece 30 is a rectangular piece of material with square corners. In an embodiment, the nose piece 30 is a rectangular piece of material with round corners.

In an embodiment, the nose piece(s) 30 is/are secured to the back panel 20 by a nose piece stitch 33. In an embodiment, at least one nose piece 30 is secured to the back panel 20 by creating a pocket or pockets between the layers of material (discussed in further detail below) with the stitch 33. In an embodiment, the nose piece 30 may move freely within the pocket. In an embodiment, the stitch 33 may pierce through the nose piece 30 to secure the nose piece 30 to the back panel 20. As noted above, the nose piece stitch 33 may comprise at least one of a top thread and a bottom thread. In an embodiment, the nose piece(s) 30 is/are secured to the back panel 20 by an adhesive. In an embodiment, the nose piece(s) 30 is/are secured to any of the layers of the back panel 20 by at least one of embroidering, sonic welding, welding, stitching, bonding, adhesion, and a thermal process. In an embodiment, the nose piece 30 is secured to the front panel 10 in the same manner as the embodiments described above.

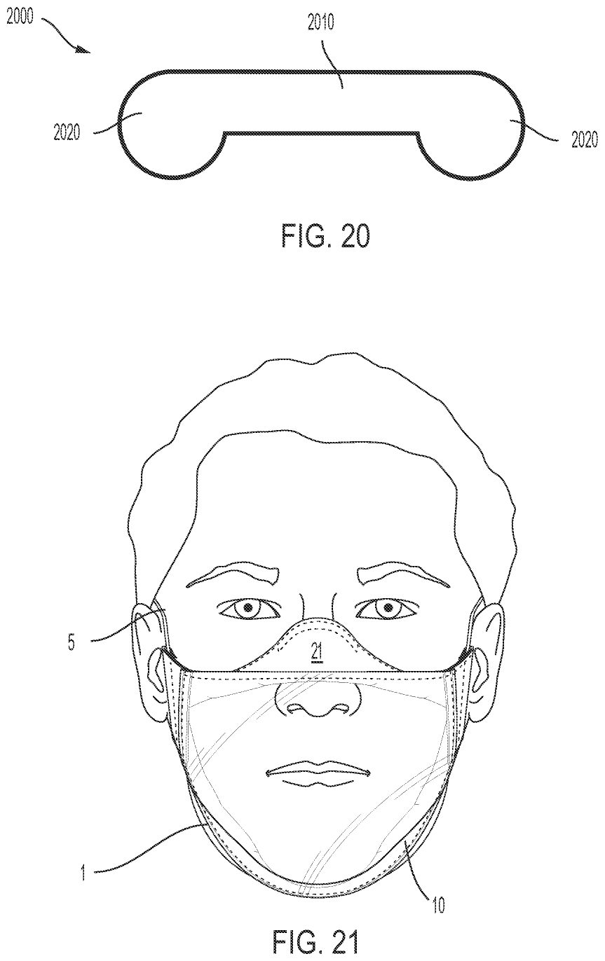

Turning briefly to FIG. 20, a front view of a nose piece 2000 with a butterfly-wing design is shown. In an embodiment, the butterfly-wing nose piece comprises a middle portion 2010 and bulbous end portions 2020. In an embodiment, the middle portion 2010 has a bar configuration wherein the top part of the bar is longer than the bottom part of the bar. In an embodiment, the bulbous end portions 2020 resemble three quarters of a circle with the left bulbous section starting at approximately at the 12 o'clock position on a watch and extending counter-clockwise to approximately the 3 o'clock position. Similarly, the right bulbous section starts approximately at the 12 o'clock position and extends clockwise to approximately the 9 o'clock position. The middle portion 2010 joining the bulbous sections at the 12 o'clock position on the top part of the bar and at the 3 and 9 o'clock positions on the bottom part of the bar. In an embodiment, the butterfly-wing nose piece 2000 allows the user to control the air passage through the nose. In an embodiment, the butterfly-wing nose piece 2000 allows the user to locally apply pressure on the nose bridge. In an embodiment, the butterfly-wing nose piece 2000 prevents the excessive fogging of reading glasses when wearing a PPE face covering (e.g., mask or respirator).

In an embodiment, the butterfly-wing nose piece 2000 is manufactured from thin gage aluminum. In an embodiment, the butterfly-wing nose piece 2000 is manufactured from polypropylene. In an embodiment, the butterfly-wing nose piece 2000 is secured to the mask by placing it between layers of a panel and embroidering a pocket around the nose piece. In an embodiment, the butterfly-wing nose piece 2000 is secured to the mask by an adhesive backing.

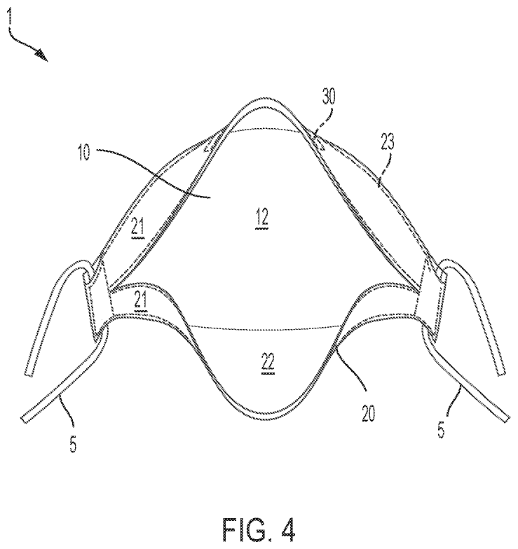

Referring now to FIGS. 4, a back view of an embodiment of a mask 1 in an expanded state is shown. In an embodiment, the mask 1 comprises additional pieces of material located throughout the top portion 26 and the bottom portion 27 to add rigidity and ensure an airtight seal between the user and the mask 1 at different parts of the face (e.g., cheeks, temple, forehead). In an embodiment, the mask 1 comprises additional pieces of material located throughout the front panel 10 to add rigidity and ensure an airtight seal between the user and the mask 1 at different parts of the face (e.g., cheeks, temple, forehead). In an embodiment, the mask 1 comprises a periphery material (not shown) around its periphery when expanded (i.e., the edges of the top portion 26 and the bottom portion 27 that contact the user) that is hidden from view when the mask 1 is worn correctly. In an embodiment, the periphery is defined by the separation line 28. In an embodiment, the mask 1 comprises a conformable material (not shown) around its periphery. In an embodiment, the conformable material 1 is a deformable member. In an embodiment, the periphery material (e.g., a deformable member) circumscribes at least a portion of the perimeter. As used herein, the term “circumscribes” comprises restricting a portion of the mask. In an embodiment, the periphery material is secured to less than the totality of the periphery. In an embodiment, the periphery material is one continuous part. In an embodiment, the periphery material may be several parts placed around the perimeter of the mask at discreet locations.

### Panel Layer Stack-up

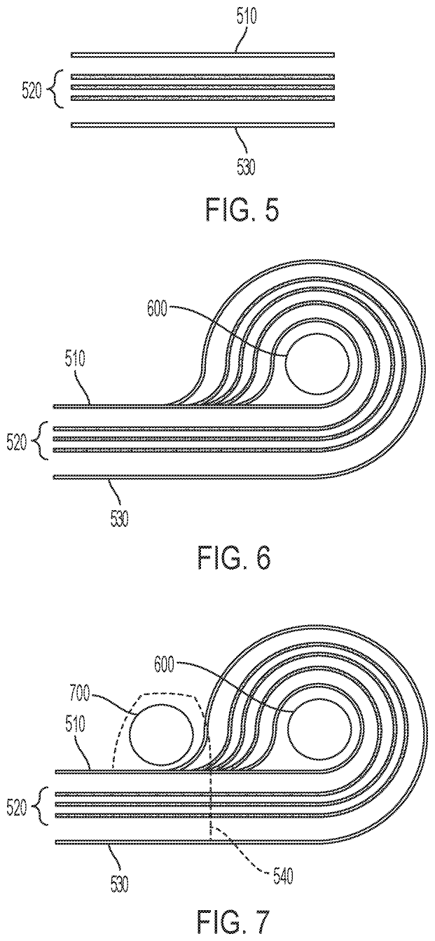

Referring now to FIG. 5, an illustrative layer stack-up of a panel (e.g., front panel 10 or back panel 20) or discrete portions of a panel is shown. In an embodiment, a panel comprises an outer layer 510, at least one intermediate layer 520, and an inner layer 530. In an embodiment, a panel comprises only one layer. In an embodiment, a panel comprises an outer layer 510 and an inner layer 530. In an embodiment, a panel comprises a plurality of intermediate layers 520. In an embodiment, a mask 1 comprises panels of different types and numbers of layers.

In an embodiment, the inner layer 530 faces the user when the mask is worn. In an embodiment, the mask layers 510, 520, and 530 may comprise any of the materials traditionally used for masks. In an embodiment, the mask layers 510, 520, and 530 may comprise a textile portion. In an embodiment, the mask layers 510, 520, and 530 may comprise a filter portion. In an embodiment, the mask layers 510, 520, and 530 may comprise a transparent portion. In an embodiment, the filter portion allows the exchange of air between the outside of the mask and the space created between the mask and the user. In an embodiment, the outside of the mask is the environment. In an embodiment, the space created between the mask and the user is referred to as an inner air space. In an embodiment, the filter portion captures at least 95% of the particles from the air that is exchanged therethrough. According to various embodiments, the filter portion may have a NIOSH filter efficiency rating of 95, 99, or 100.

As will be apparent to those skilled in the art, the materials used in the manufacture of mask 1 are non-limiting; embodiments disclosed herein may be manufactured out of a wide variety of materials. In an embodiment, at least one of the outer layer 510, the inner layer 520, and the outer layer 530 are manufactured out of at least one of polypropylene, polystyrene, polycarbonate, polyethylene, polyester, cotton, synthetic, and natural fibers. In an embodiment, at least one of the outer layer 510, the at least one intermediate layer 520, and the inner layer 530 is Hanes™ Elite 180 Polypropylene Lining. In an embodiment, at least one of the outer layer 510, the at least one intermediate layer 520, and the inner layer 530 is Freudenberg, Evolon® 100 microfilament fabric. In an embodiment, at least one of the outer layer 510, the at least one intermediate layer 520, and the inner layer 530 is Tekra® Melinex® AF2 clear polyester film. In an embodiment, at least one of the outer layer 510, the at least one intermediate layer 520, and the inner layer 530 is a transparent material coated with an anti-fog coating.

In an embodiment, at least one of the outer layer 510, the intermediate layer(s) 520 (if used), and the inner layer 530 is secured to at least one of the other layers by at least one of embroidering, sonic welding, welding, stitching, bonding, adhesion, and a thermal process. In an embodiment, at least one of the outer layer 510, the intermediate layer(s) 520 (if used), and the inner layer 530 is at least one of a filtering material, a textile, a plastic, and a foam. In an embodiment, the layer stack-up includes materials localized to only some parts of the front panel 10 or the back panel 20.

In an embodiment, the panels of mask 1 comprise portions of foam over areas that contact the skin of the user (e.g., forehead, chin, nose). In an embodiment, at least one foam portion is provided to mitigate the discomfort a user may feel by the pressure applied from a snuggly fitting mask.

Referring now to FIG. 6, an illustrative layer stack-up of a panel or discrete portions of a panel which include a material 600 (e.g., nose piece 30) near its periphery is shown. In an embodiment, at least a portion of the periphery contacts the skin of the user. In an embodiment, the material 600 is a shape-conformable material. In an embodiment, the material 600 is a transmission component of a mask-fit test system. In an embodiment, the material 600 is a shape-conformable member which comprises a pliable material that is able to conform to the facial features of a user. In an embodiment, the material 600 is a shape-conformable member which comprises a non-slip material capable of forming an air-tight seal with the skin of a user. In an embodiment, the portion of the mask surrounding the material 600 comprises a non-slip material capable of forming an air-tight seal with the skin of a user. In an embodiment, material 600 comprises metal. In an embodiment, the metal is at least one of aluminium, steel, copper, and brass. In an embodiment, the material 600 comprises plastic. In an embodiment, the material 600 comprises a plastic that is pliable at room temperature, and retains its plied shape. In an embodiment, the material 600 comprises a plastic that is pliable at temperature higher than room temperature, but retains its plied shape at the temperature encountered when worn by a user. In an embodiment, the material 600 is pliable in one state, e.g., before being exposed to air or another chemical, and sets to a shape-retaining state after such exposure. In an embodiment, the material comprises a two-part epoxy in a tube. In an embodiment, the mask is vacuum packed, and all or a portion of the material 600 sets after contact with air.

In an embodiment, the material 600 is placed at an edge of the layer stack-up and one or more of the layers are folded there-around towards the outer layer 510 to secure the material 600 to the mask. In an embodiment, the material 600 is placed at the edge of the layer stack-up and one or more layers are folded there-around towards the inner layer 530 to secure the material 600 to the mask. In an embodiment, the material 600 is secured to or near the periphery of the mask 1. As may be noted by those skilled in the art, in an embodiment, when secured with the layer stack-up, the material 600 can deform to allow the mask 1 to conform to the physical features of the user without leaving gaps between the skin and the mask. In an embodiment, the material 600 is affixed to the mask 1 by embroidery. In an embodiment, the material 600 is affixed to the mask 1 by at least one of sonic welding, welding, stitching, bonding, adhesion, and a thermal process. In an embodiment, the material 600 is secured to at least one of the outer layer 510 and the inner layer 530. In an embodiment, the material 600 is directly embroidered to at least one of the outer layer 510 and the inner layer 530.

Turning now to FIG. 7, an illustrative layer stack-up of a panel or discrete portions of a panel which include at least one of a material 600 (e.g., nose piece 30) and a light transmitting portion 700 near its periphery is shown. As will be discussed in further detail below, in an embodiment, the light transmitting portion 700 is part of a mask-fit test system. In an embodiment, when secured to the layer stack-up around the periphery of the mask 1, the light transmitting portion can deform to allow the light transmitting portion 700 to conform to the shape of the periphery of the mask 1. In an embodiment, the light transmitting portion 700 can be affixed to the mask 1 by at least one of embroidering, sonic welding, welding, stitching, bonding, adhesion, and a thermal process. In an embodiment, the light transmitting portion is secured to the outer layer 510. In an embodiment, the light transmitting portion is embroidered directly to the outer layer 510. In an embodiment, the light transmitting portion is secured to the inner layer 530. In an embodiment, the light transmitting portion is embroidered directly to the inner layer 530. In an embodiment, the light transmitting portion is placed between the outer and inner layers and portions of at least one of the outer and inner layers are cut out to allow light to shine through to the interior of the mask (i.e. facing the user). In an embodiment, the light transmitting portion is embroidered to the mask 1 in the interior of the mask whereby segments of the light transmitting portion shine through to the interior of the mask. As will be noted later in this disclosure, the light transmitting portion can also be placed at other parts of mask 1 in the interior of the mask facing the user to illuminate the interior of the mask. In an embodiment, a plurality of light transmitting portions are placed throughout the interior of the mask. In an embodiment, the light transmitting portion can transmit light inside of the mask 1 when the mask 1 is placed on the user.

In an embodiment, at least one of a material 600 and a light transmitting portion 700 is placed between the outer layer 510 and the inner layer 530. In an embodiment, at least one of a material 600 and a light transmitting portion 700 is placed between at least one of the outer layer 510, at least one intermediate layer 520 (if used), and an inner layer 530. In an embodiment, at least one of a material 600 and a light transmitting portion 700 are secured using stitching 540. In an embodiment, the material 600 and light transmitting portion 700 are placed side by side wherein the material 600 is secured by folding the layers there-around and embroidering the light transmitting portion 700 directly to at least one of the outer layer 510 and inner layer 530. In an embodiment, the material 600 and light transmitting portion 700 are placed side by side between the outer layer 510 and the intermediate layers 520.

In an embodiment, the light transmitting portion 700 is a fiber optic cable. In an embodiment, the light transmitting portion 700 is a light strip. In an embodiment, the light transmitting portion includes LEDs. In an embodiment, the light transmitting portion 700 is placed at the edge of the layer stack-up and then the layers are folded towards the outer layer 510 and secured to each other. In an embodiment, the light transmitting portion is placed at the edge of the layer stack-up and then the layers are folded towards the inner layer 530 and secured to each other. In an embodiment, the light transmitting portion is secured to the periphery of the mask 1.

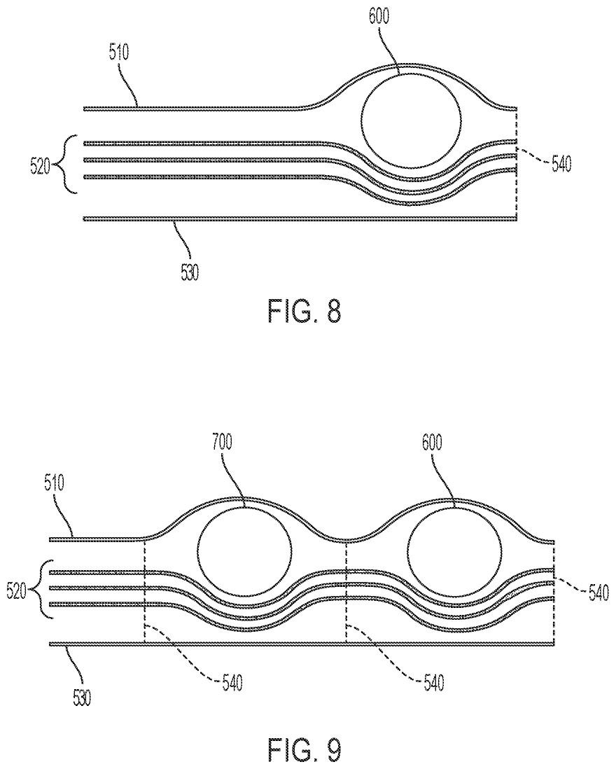

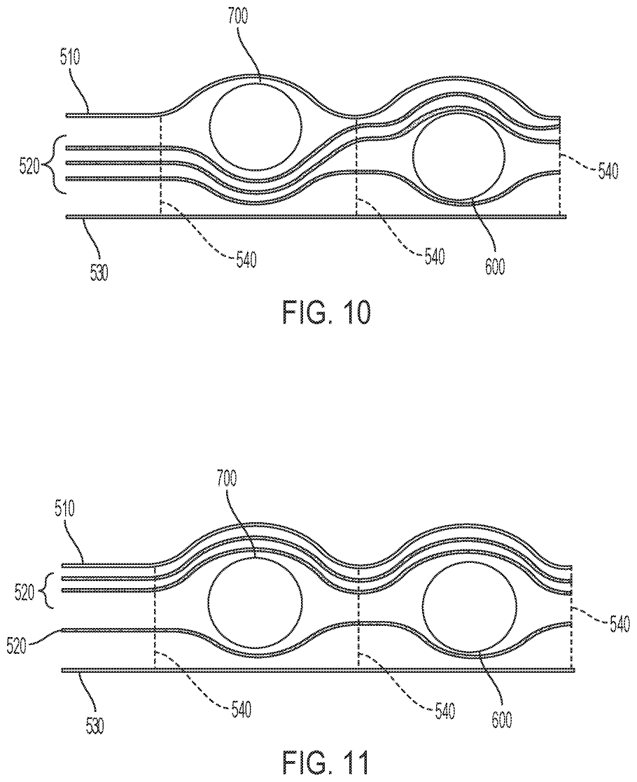

FIGS. 8 through 11 illustrate embodiments where the material 600 and light transmitting portion 700 are placed in different configurations with respect to each other and the mask layers. As may be noted by those skilled in the art, the arrangement and order of at least one of the material 600, the light transmitting portion 700, and the several layers is non-limiting and may be achieved in a plurality of ways.

### Seal Assessment System

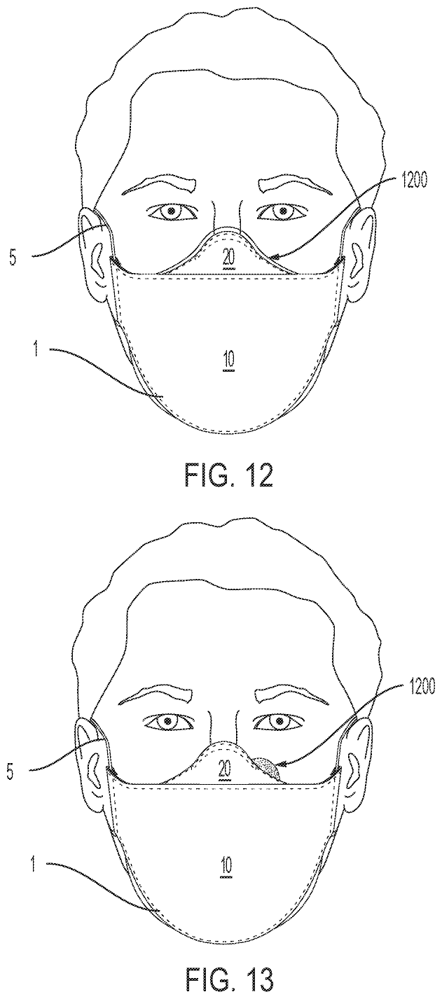

Turning now to FIGS. 12 and 13, a face mask 1 comprising a mask-fit test system and worn by a user is shown. In an embodiment, the mask-fit test system comprises the light transmitting portion 700. In an embodiment, the mask-fit test system is contained inside the mask 1 and transmits light from inside the mask 1. In an embodiment, when any part of the skin contacting portion of the mask 1 is away from the face, light will project onto the skin and bleed outside the periphery of the mask 1 thereby showing as light bleed 1200. In FIG. 13, light bleed 1200 materializes in places where a gap between the mask 1 and the skin exists. In an embodiment, when no gaps exist, little to no light bleed 1200 will materialize. As noted above, even when no gap exists some light can bleed through the skin but it will be attenuated to a level below the energy level of light that will bleed if a gap exists.

In an embodiment, the mask-fit test system includes a transmission source (not shown). In an embodiment, the transmission source includes a circuitry and power to enable a transmission of an electromagnetic signal (e.g., visible light) from within the mask 1. In an embodiment, the transmission source transmits from outside the mask. In an embodiment, the transmission source is separate from the mask 1 while the light transmitting portion 700 is contained in the mask 1.

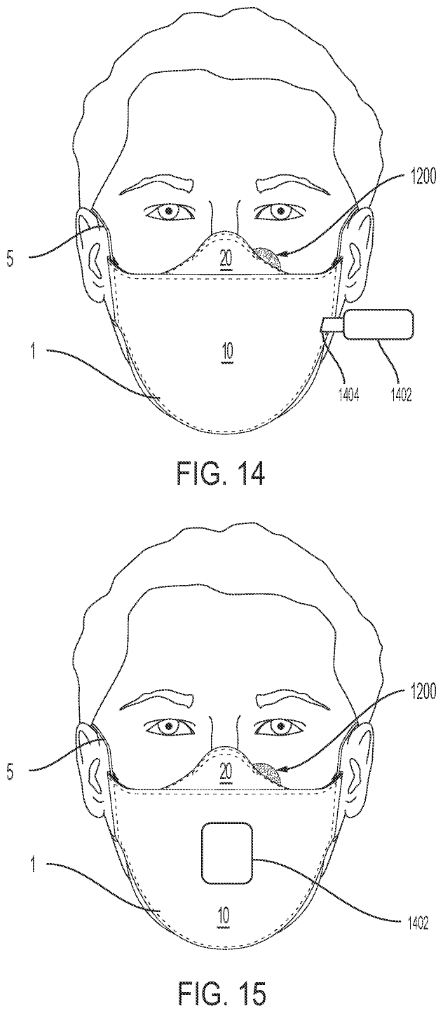

FIGS. 14 and 15 illustrate embodiments where the transmission source 1402 is outside the mask. In an embodiment, the transmission source 1402 is separate from the mask 1. In an embodiment, the transmission source 1402 is secured to the outside of the mask 1. In an embodiment, the mask 1 includes a port 1404. In an embodiment, the port 1404 is connected to the light transmitting portion 700. In an embodiment, the source 1402 connects to the light transmitting portion 700 through the port 1404. In an embodiment, the source 1402 includes a light source to transmit light through the port 1404 to the light transmitting portion 700. In an embodiment, the port 1404 is a lens whereby light can be transmitted from outside the mask to the inside of the mask. In an embodiment, the port 1404 is a thru-mask fitting to allow light to be transmitted from outside the mask to the inside of the mask. In an embodiment, the thru-mask fitting allows a device to be connected to the mask to allow light to shine therethrough. In an embodiment, the thru-mask fitting may prevent light from shining therethrough when no device is connected. In an embodiment, the thru-mask fitting includes a lens.

### Physical Implementations

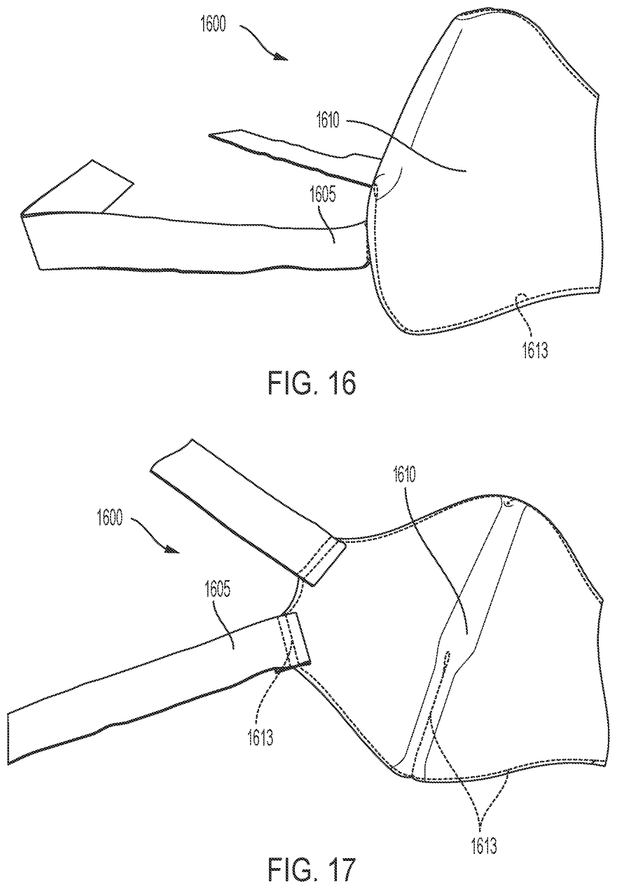

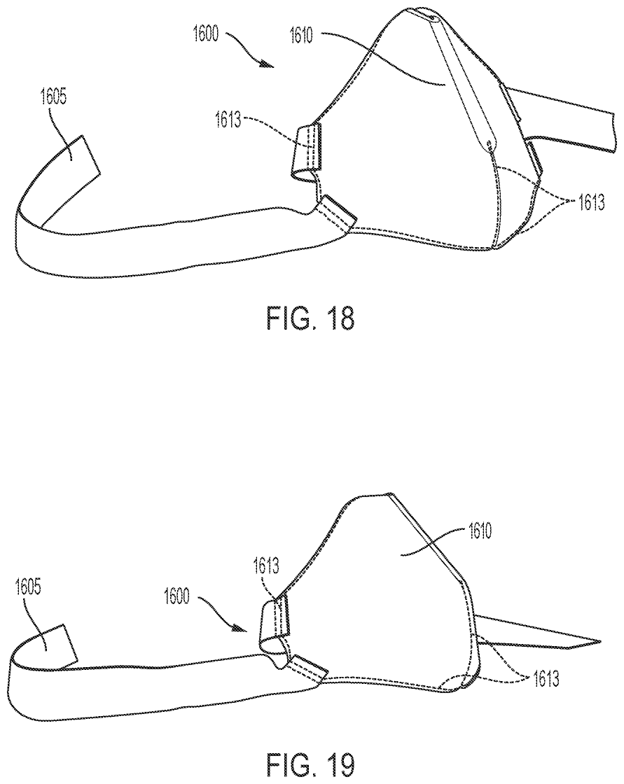

FIGS. 16 through 19 show isometric views of a face mask 1600 with a single panel in an expanded state. In an embodiment, a mask 1600 includes a front panel 1610, straps 1605, and stitching 1613. In an embodiment, the front panel 1600 comprises a front layer and a back layer. In an embodiment, the back layer faces the user when the mask is worn.

In an embodiment, the straps 1605 form part of a mask securing system. In an embodiment, the mask securing system comprises fasteners (e.g., snaps and buckles). In an embodiment, at least some of the stitching 1613 is shown through the front layer of the front panel 1610. In an embodiment, at least some of the stitching 1613 is shown through the back layer. In an embodiment, no stitching 1613 is shown through either the front layer or the back layer. In an embodiment, the stitching 1613 is not visible. In an embodiment, the stitching 1613 is concealed between layers.

In an embodiment, the straps 1605 can be integrally manufactured with the front panel 1610. In an embodiment, the straps 1605 can be integrally manufactured with at least one of the front layer and the back layer of the front panel 1610. In an embodiment, the straps 1605 can be integrally manufactured with all the layers of the mask 1600. In an embodiment, the straps 1605 are integrally manufactured with only some of all the layers on the mask 1600. In an embodiment, the straps 1605 are manufactured from a different material than the mask 1600. In an embodiment, the straps 1605 are manufactured from the same material as the mask 1600. In an embodiment, the straps 1605 are secured to at least one layer by at least one of embroidering, sonic welding, welding, stitching, bonding, adhesion, and a thermal process.

The front panel 1610 may comprise any of the materials traditionally used for masks. In an embodiment, at least one of the layers of the front panel 1610 are manufactured out of at least one of polypropylene, polystyrene, polycarbonate, polyethylene, polyester, cotton, and natural fibers. In an embodiment, at least some of the layers of the front panel 1610 may comprise a textile portion. In an embodiment, at least some of the layers of the front panel 1610 may comprise a filter portion. In an embodiment, the filter portion allows the exchange of air between the outside of the mask and the space created between the mask and the user. In an embodiment, the outside of the mask is the environment. In an embodiment, the space created between the mask and the user is referred to as an inner air space. In an embodiment, the filer portion captures at least 95% of the particles from the air that is exchanged therethrough. According to various embodiments, the filter portion may have a NIOSH filter efficiency rating of 95, 99, or 100. As will be apparent to those skilled in the art, the materials used in the manufacture of mask 1600 is non-limiting; embodiments disclosed herein may be manufactured out of a wide variety of materials.

### Colorimetric Mask Sensor

As indicated elsewhere in this disclosure, some masks include transparent front panels or windows to enable others to see the user's face thereby enhancing communication. These transparent panels—usually passive components—can be leveraged as conduits for a variety of sensors based on colorimetric mechanisms. In an embodiment, a temperature sensor in the form of a sticker is affixed through an adhesive to the transparent window. The temperature sensor changes color depending on the ambient temperature that it is exposed to.

In an embodiment, a colorimetric temperature sensor is used to indicate the body temperature of the user. This approach can allow third parties to easily identify users that may be ill while remaining at a safe distance. Moreover, the sensor can be configured with a non-reversible maximum. That is, once the temperature reaches a threshold, it triggers a color change and remains at that color. In an embodiment, a colorimetric temperature sensor is reversible. That is, the color changes dynamically with temperature (e.g. turn red above a threshold and turn green once it returns to a temperature below the threshold). In an embodiment, a colorimetric temperature sensor is combined with a computer system that tracks and logs the changes in temperature. In an embodiment, a colorimetric respiration sensor is combined with a computer system that tracks and logs the changes in the breathing rate of the user. In an embodiment, a colorimetric sensor can measure and indicate at least one of temperature, humidity, and the presence or absence of aldehydes, acetone, and hydrogen sulfide.

### Bio-Laminate Transparent Panel

Referring now to FIG. 21, a front view of an embodiment of a face mask 1 with a transparent front panel 10 in an expanded state worn by a user is shown. In an embodiment a mask 1 includes a front panel 10 and a back panel 20. In an embodiment, the front panel 10 and the back panel 20 have generally the same outline. In an embodiment, the front panel 10 and the back panel 20 have different outlines. In an embodiment, the front panel 10 comprises a transparent portion and a filtration portion. In an embodiment, the front panel 10 comprises a transparent portion and a textile portion.

In an embodiment, the mask is placed over the mouth and nose of the user. In an embodiment, the mask is placed over the eyes, nose, and mouth of the user and can comprise a transparent portion for others to observe the eyes, nose, and mouth of the user. In an embodiment, an embroidered mask is manufactured and stored in a substantially flat or collapsed state and is capable of unfolding to a three dimensional expanded state. In an embodiment, the transparent front panel 10 or the transparent portion of the front panel 10 is manufactured out of polyethylene terephthalate (PET). PET is a petroleum based non-biodegradable plastic.

However, aspects of this disclosure contemplate a biodegradable transparent panel that provides protection against the transmission of biological material and retains a strong structural integrity. Cellulose acetate sheets offer a clear, bio-based alternative to polyethylene terephthalate (PET) that is degradable within traditional landfill environments. Yet, cellulose acetate sheets are not as cost effective in thick-sheet form as PET. The use of multiple laminated sheets of the cellulosic polymeric laminates bound by the bio-adhesive allows for a property-tunable material set. In an embodiment, a biodegradable transparent panel is created by laminating relatively inexpensive cellulose acetate sheets with a bio-based adhesive that retain the mechanical property requirements of a PPE panel. In an embodiment, a biodegradable transparent panel has a transparency >90%. In an embodiment, a biodegradable transparent panel is capable of being formed using traditional plastic forming methods (e.g., vacuum forming). In an embodiment, a biodegradable transparent panel is 100% biodegradable.

In an embodiment, a mask 1 comprising a biodegradable transparent panel is 100% biodegradable. In an embodiment, the biodegradable transparent panel comprises a combination of cellulosic polymeric laminates with a bio-adhesive. In an embodiment, a bio-adhesive is produced from soy, protein or other bio-based polyols combined with cross-linking agents such as tailored amines. In an embodiment, the bio-adhesive is curable with ultraviolet (UV) light.

In an embodiment, a biodegradable transparent panel also has anti-fogging properties. It will be noted that regenerated celluloses have a hydrophilic surface, thus exhibiting good anti-fogging properties. Regenerated celluloses are inexpensive and commercially available (e.g., NatureFlex™ series products by Futamura USA Inc., Atlanta, Ga.). However, commercial cellulose products have a thickness typically ranging from 0.020 mm to 0.038 mm, which are too thin by themselves to be used in lieu of PPE.

In an embodiment, a biodegradable transparent panel comprises two cellulose acetate sheets separated by a bio-adhesive. In an embodiment, a biodegradable transparent panel comprises two cellulose acetate sheets separated by a soy-based bio-adhesive. In an embodiment, a biodegradable transparent panel comprises three cellulose acetate sheets, each sheet separated from an adjacent sheet by a bio-adhesive. In an embodiment, a biodegradable transparent panel comprises four cellulose acetate sheets, each sheet separated from an adjacent sheet by a bio-adhesive. In an embodiment, a biodegradable transparent panel comprises 5 or more cellulose acetate sheets, each sheet separated from an adjacent sheet by a bio-adhesive.

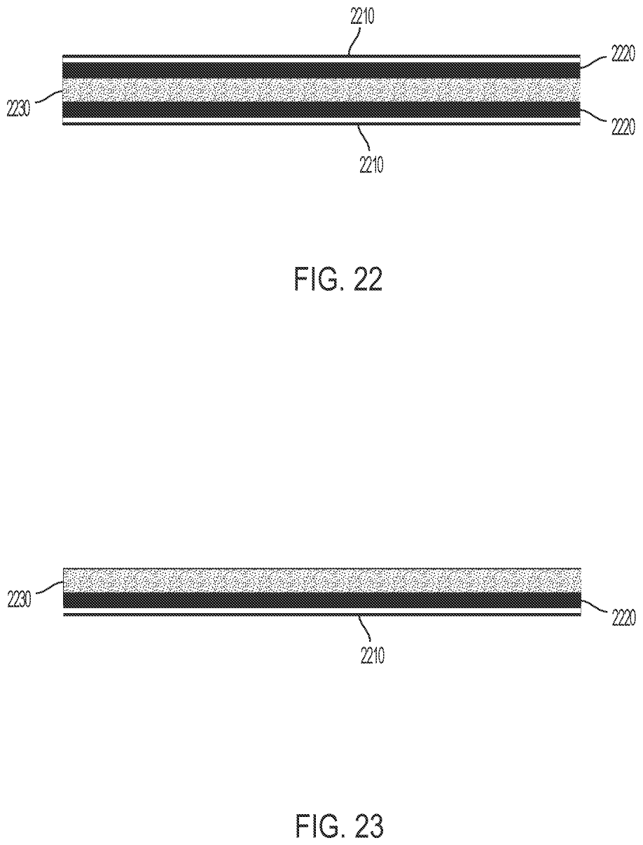

Turning now to FIGS. 22-23, an illustrative layer stack-ups of a biodegradable transparent panel or discrete transparent portions of a panel are shown. In an embodiment, a biodegradable transparent panel 2200 comprises five layers: two outer layers 2210, two adhesive layers 2220, and an inner layer 2230. In an embodiment, a biodegradable transparent panel 2200 comprises three layers: an outer layer 2210, an adhesive layer 2220, and an inner layer 2230. In an embodiment, a biodegradable transparent panel 2000 may have a thickness ranging from 0.125 mm to 0.180 mm. In an embodiment, the outer layers 2210 comprise regenerated cellulose film. In an embodiment, the outer layers 2210 provide anti-fogging properties. In an embodiment, the outer layers 2210 may have a thickness ranging from 0.01 mm to 0.04 mm. In an embodiment, the adhesive layers 2220 comprises a bio-adhesive. In an embodiment, the bio-adhesive is soy-based. In an embodiment, the bio-adhesive is UV curable. In an embodiment, the adhesive layer 2220 may have a thickness ranging from 0.01 mm to 0.05 mm. In an embodiment, an inner layer 2230 comprises regenerated cellulose or cellulose derivatives such as cellulose acetate and nitrocellulose. In an embodiment, the inner layer 2230 may have a thickness ranging from 0.04 mm to 0.15 mm.

An aspect of the present invention is a protective face mask comprising a main textile portion adapted to be worn over the mouth and nose of a user thereby creating creating an inner air space, the main textile portion comprising a perimeter and a filter portion, the filter adapted to permit the exchange air between the environment and the inner air space. The protective face mask further comprising a deformable member secured to the main textile portion near the perimeter, the deformable member circumscribing at least a majority of main textile portion, and being adapted to be conformed to the physical features of a user's face through the use of pressure, such that when the deformable member is so conformed, the mask will fit snugly against the user's face so that there are no gaps between skin on the user's face and the deformable member, thereby creating an inner air space; a mask securing system operatively affixed to the main textile portion for keeping the face mask securely in place during breathing; and, a light emitting system adapted to produce light in the inner air space directed towards at least a portion of the perimeter, wherein light from the light emitting system will illuminate skin on the user's face outside the perimeter if there is a gap between the perimeter and the user's face at the at least a portion of the perimeter.

Another aspect of the invention is a mask fit device for use with a mask having a perimeter adapted to fit snugly against a user's face such that there are no gaps between skin on the user's face and the perimeter when used as intended, and, when fit snugly, the mask creating an inner air space. In an embodiment, the mask fit device comprises a light emitting system adapted to produce light in the inner air space directed towards at least a portion of a perimeter of a mask, wherein light from the light emitting system will illuminate skin on the user's face outside the perimeter if there is a gap between the perimeter and the user's face at the at least a portion of the perimeter. In an embodiment, the mask fit device comprises a radiating system secured adjacent to the perimeter, the radiating system adapted to emit radiation in the inner air space, wherein radiation from the radiating system will escape from the inner air space if there is a gap between the perimeter and the user's face.

Yet another aspect of the invention is a protective face mask comprising a main textile portion adapted to be worn over the mouth and nose of a user thereby creating creating an inner air space, the main textile portion comprising a perimeter and a filter portion, the filter adapted to permit the exchange air between the environment and the inner air space. The protective face mask further comprising a deformable member secured to the main textile portion near the perimeter, the deformable member circumscribing at least a majority of main textile portion, and being adapted to be conformed to the physical features of a user's face through the use of pressure, such that when the deformable member is so conformed, the mask will fit snugly against the user's face so that there are no gaps between skin on the user's face and the deformable member, thereby creating an inner air space. The protective face mask comprises a mask securing system operatively affixed to the main textile portion for keeping the face mask securely in place during breathing; and, a light emitting system adapted to produce light in the inner air space directed towards at least a portion of the perimeter, wherein light from the light emitting system will illuminate skin on the user's face outside the perimeter if there is a gap between the perimeter and the user's face at the at least a portion of the perimeter.

While the invention has been particularly shown and described with reference to a preferred embodiment thereof, it will be understood by those skilled in the art that various changes in form and details may be made therein without departing from the spirit and scope of the invention.

What is claimed is:

1. A protective face mask comprising:
a main textile portion adapted to be worn over the mouth and nose of a user, the main textile portion comprising a perimeter and a filter portion;
a deformable member secured to the main textile portion near the perimeter, the deformable member circumscribing at least a majority of main textile portion, and being adapted to be conformed to the physical features of a user's face through the use of pressure, such that when the deformable member is so conformed, the mask will fit snugly against the user's face so that gaps between skin on the user's face and the deformable member are reduced, thereby creating an inner air space; and,
a mask securing system operatively affixed to the main textile portion for keeping the face mask securely in place during breathing;
the filter adapted to permit the exchange air between the environment and the inner air space.

2. The protective face mask of claim 1, wherein the filter captures at least 95% of particles having a size corresponding to a mass median aerodynamic diameter of about 0.3 microns that is exchanged therethrough.

3. The protective face mask of claim 1, wherein the deformable member comprises a metal wire.

4. The protective face mask of claim 1, wherein the deformable member comprises a cushioned portion to mitigate discomfort to the user.

5. The protective face mask of claim 1, wherein the deformable member is secured to the main textile by embroidery.

6. A mask fit device for use with a mask having a perimeter adapted to fit snugly against a user's face such that gaps between skin on the user's face and the perimeter are reduced when used as intended, and, when fit snugly, the mask creating an inner air space, the mask fit device comprising:
a light emitting system adapted to produce light in the inner air space directed towards at least a portion of a perimeter of a mask, wherein light from the light emitting system will illuminate skin on the user's face outside the perimeter if there is a gap between the perimeter and the user's face at the at least a portion of the perimeter.

7. The mask fit device of claim 6, wherein the light emitting system includes a lens to allow light to be transmitted from outside the inner air space.

8. The mask fit device of claim 6, wherein the light emitting system includes a thru-mask fitting to allow light to be transmitted from outside the inner air space.

9. The mask fit device of claim 6, wherein the light emitting system includes a fiber optic cable.

10. The mask fit device of claim 6, wherein the light emitting system includes at least one light emitting diode (LED).

11. The mask fit device of claim 6, wherein the light emitting system is adapted to be installed within the inner air space.

12. The mask fit device of claim 6, wherein the light emitting system includes a fiber optic cable (e.g., Fibrance) near the perimeter.

13. The mask fit device of claim 12, wherein the fiber optic cable is illuminated from outside the inner air space.

14. The mask fit device of claim 12, wherein the fiber optic cable is illuminated from inside the inner air space.

15. A mask fit device for use with a mask having a perimeter adapted to fit snugly against a user's face such that gaps between skin on the user's face and the perimeter are reduced when used as intended, and, when fit snugly, the mask creating an inner air space, the mask fit device comprising:
a radiating system secured adjacent to the perimeter, the radiating system adapted to emit radiation in the inner air space, wherein radiation from the radiating system will escape from the inner air space if there is a gap between the perimeter and the user's face.

16. The mask fit device of claim 15, wherein the radiating system radiates visible light.

17. The mask fit device of claim 15, wherein the radiating system radiates non-visible light (e.g., infrared or ultraviolet).

18. The mask fit device of claim 15, further comprising a detector for detecting escaped radiation.

19. A protective face mask comprising:
a main textile portion adapted to be worn over the mouth and nose of a user thereby creating an inner air space, the main textile portion comprising a perimeter and a filter portion, the filter adapted to permit the exchange air between the environment and the inner air space;
a deformable member secured to the main textile portion near the perimeter, the deformable member circumscribing at least a majority of main textile portion, and being adapted to be conformed to the physical features of a user's face through the use of pressure, such that when the deformable member is so conformed, the mask will fit snugly against the user's face so that gaps between skin on the user's face and the deformable member are reduced, thereby creating an inner air space;
a mask securing system operatively affixed to the main textile portion for keeping the face mask securely in place during breathing; and,
a light emitting system adapted to produce light in the inner air space directed towards at least a portion of the perimeter, wherein light from the light emitting system will illuminate skin on the user's face outside the perimeter if there is a gap between the perimeter and the user's face at the at least a portion of the perimeter.
